(19) United States
(12) Patent Application Publication
(10) Pub. No.: US 2018/0281530 A1
(43) Pub. Date: Oct. 4, 2018

(54) TEARDROP SIPE PROFILE FOR TIRE

(71) Applicant: Compagnie Generale des Etablissements Michelin, Clermont-Ferrand (FR)

(72) Inventors: Robert LAWSON, Pelzer, SC (US); Phillip William CHECK, Simpsonville, SC (US)

(21) Appl. No.: 15/765,058

(22) PCT Filed: Sep. 15, 2015
(86) PCT No.: PCT/US2015/053078

§ 371 Date: Mar. 30, 2018

(51) Int. Cl. B60C 11/12

(52) U.S. Cl. CPC B60C 11/1281; B60C 11/1218

(57) ABSTRACT

A tire for a vehicle is provided that has a tread that includes a sipe located in the tread. The sipe has an upper portion (26) that has an upper portion cross-sectional width. The sipe also has a teardrop void (30) located closer to a central axis of the tire than the upper portion. The teardrop void (30) has a maximum cross-sectional width that is not greater than 2.3 millimeters.

### FIELD OF THE INVENTION

The subject matter of the present invention relates to a sipe for a tire that has a teardrop profile. More particularly, the present application involves a micro teardrop sipe for a tire that has a geometry that results in improved sculpture robustness, reduced risk of irregular wear, and optimized end-of-life tread geometry.

### BACKGROUND OF THE INVENTION

Tires normally include tread that has a series of ribs that extend in a circumferential direction of the tire separated in the axial direction by grooves. The ribs may be provided with a series of sipes that can function to improve traction in certain road conditions. The sipes are thin slits cut into the ribs and may be configured in a variety of manners. For instance, the shape along the lengths of the sipes may be straight, zigzagging, undulating, or angled into the tire elements. The sipe depths may also vary or be consistent along their lengths, and may extend into the tread all the way to the end of life tread depth. The sipes may close within the tire “footprint” on the road, and can increase the flexibility of the tread block into which the sipes are located. The presence of sipes can improve stopping distance, breakaway traction, and rolling traction on glare ice. Additionally sipes have been found to improve traction for tires in snow, mud, and other types of ice.

It is known to provide sipes with a teardrop shape that tends to increase traction of the tire when the tire is near the end of its life. The teardrop feature in the sipe is an increase in the circumferential length of the sipe at an area of the sipe closer to the center of the tire in the radial direction. This increase in circumferential length causes the sipe to have a larger void radially closer to the tire center than portions of the sipe radially farther form the tire center. When the tire tread wears down, the larger void portion will open up and be exposed to the road surface and will improve traction and water removal when the tire is nearing the end of its life.

Although the inclusion of sipes helps improve tire performance in certain areas, the addition of these cut features into the ribs of the tire may also cause a risk of irregular wear on the ribs, increased rolling resistance, degradation in sculpture robustness, and a risk of increased chipping and chunking. When operated on dry surfaces, the presence of sipes may increase tire noise and wear. Because there is a reduction of tire performance in certain areas upon the inclusion of sipes in a tire, refinement of sipe characteristics may function to minimize or eliminate these negative qualities. As such, there remains room for variation and improvement within the art.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a tire that includes sipes in the tread of the tire.

FIG. 2 is a top view of a circumferential section of a tire that includes sipes in accordance with one exemplary embodiment.

FIG. 3 is a cross-sectional view taken along line 3-3 of FIG. 2.

FIG. 4 is a cross-sectional view of a portion of a sipe in accordance with an alternative exemplary embodiment.

FIG. 5 is a cross-sectional view of a portion of a sipe in accordance with yet another alternative exemplary embodiment.

FIG. 6 is a comparison between the size and shape of a teardrop of a sipe as presently provided versus that of a previously known sipe.

FIG. 7 is a cross-sectional view of a prior art pair of sipes that lack a teardrop void.

FIG. 8 is a cross-sectional view of the prior art pair of sipes of FIG. 7 with a known teardrop void incorporated therein.

FIG. 9 is a cross-sectional view of a pair of sipes without a teardrop void.

FIG. 10 is a cross-sectional view of the pair of sipes of FIG. 9 with the teardrop voids incorporated therein.

The use of identical or similar reference numerals in different figures denotes identical or similar features.

### DETAILED DESCRIPTION OF THE INVENTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a tire 10 that includes a sipe 16 that has a teardrop void 30 that can increase certain performance characteristics of the tire 10 such as traction. The sipe 16 provided may be informally referred to as a “micro teardrop sipe” because it is smaller in cross-sectional size and has a different cross-sectional geometry than other previously known sipes. The sipe 16 may have improved sculpture robustness, a reduced risk of irregular wear, and optimized geometry for end-of-life tread depth. The teardrop void 30 may have a transition portion 46, a middle section 38, and a bottom 34. The maximum cross-sectional width 32 of the teardrop void may be no greater than 2.3 millimeters in accordance with certain exemplary embodiments. In some arrangements, the maximum cross-sectional width 32 is 1.5 millimeters.

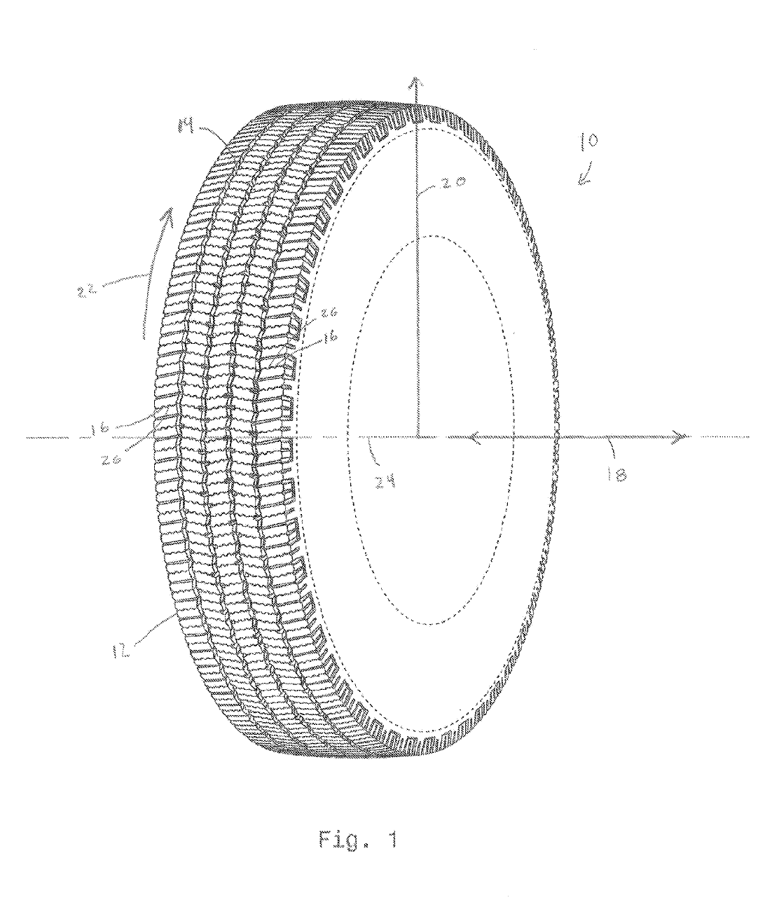

With reference to FIG. 1, a tire 10 is illustrated in perspective view that has a central axis 24 that serves as the axis of rotation of the tire 10. The central axis 24 extends through the center of the tire 10 and is aligned in the axial direction 18. The radial direction 20 of the tire 10 extends outward from the central axis 24 and is perpendicular to the central axis 24. The tire 10 also has a circumferential direction 22 that extends around the circumference of the tire 10 and circles the central axis 24. The circumferential direction may be located at any distance from the central axis 24 in the radial direction 20 of the tire 10, and need not be located only at the tread 12 or the outer most portion of the tire 10 in the radial direction 20.

The tire 10 has tread 12 organized into a series of ribs 13 separated by circumferential grooves 14 that extend along the entire length of the tire 10 in the circumferential direction 22. The ribs 13 have sipes 16 located therein that extend across the entire length of the ribs 13 in the axial direction 18. The sipes 16 are shown as having a zig-zag portion, but it is to be understood that the sipes 16 can have lengths extending in other shapes as desired. The sipes 16 may extend completely in the axial direction 18, or may extend at an angle to the axial direction 18 so that the sipes 16 in effect extend both in the axial direction 18 and in the circumferential direction 22. The sipes 16 may have a depth in the radial direction 20 to the bottom of the tread 12, or to some depth that is just above the bottom of the tread 12 in the radial direction 20.

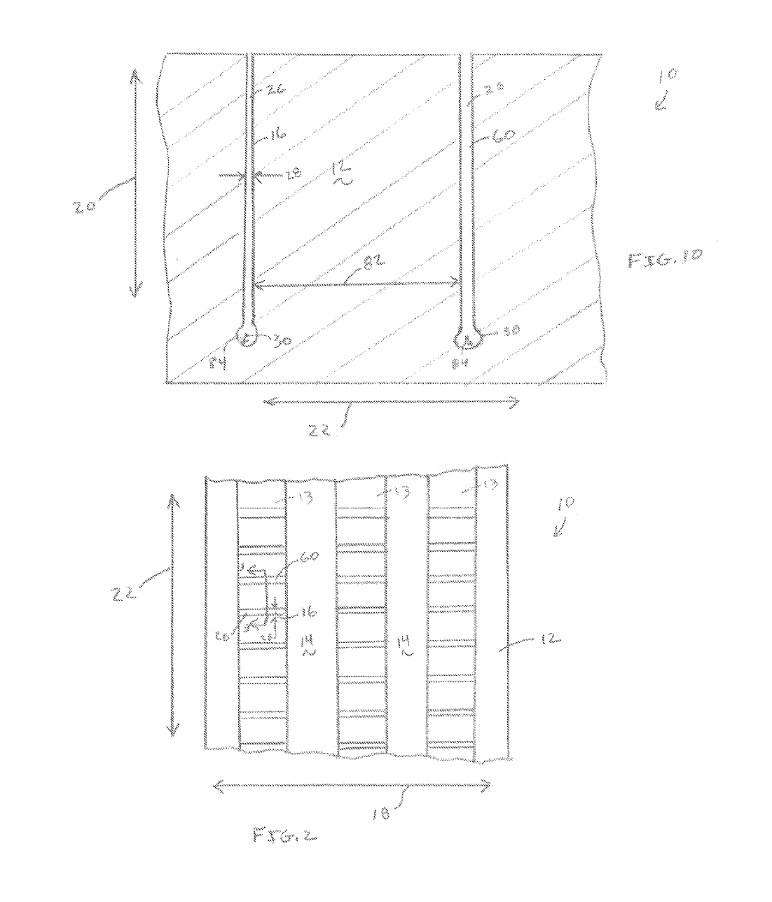

FIG. 2 shows a section of the tire 10 in accordance with one exemplary embodiment in which the sipes 16 extend completely in the axial direction 18 and are not angled so as to extend as well in the circumferential direction 22. The sipes 16 are open at the top surface of the tread 12 and are all uniformly distributed on each one of the ribs 13, although it is to be understood that the sipes 16 need not be identical to one another or uniformly distributed in accordance with other exemplary embodiments. Further, the sipes 16 in other versions may extend at an angle in the axial direction 18 so that they have a component of extension both in the axial direction 18 and in the circumferential direction 22.

Sipes 16 are cuts/voids in the tread 12 that have a width of up to 2 millimeters. If the cut/void is greater than 2 millimeters, the feature is called a groove. The grooves can be oriented in the same manner as the sipes 16 in FIG. 2 such as extending in the axial direction 18 across the entire axial length of one of the ribs 13. Also, the grooves may extend at an angle in the axial direction 18 so as to have a component of extension both in the axial direction 18 and in the circumferential direction 22. The grooves can also have a variety of shapes along their lengths such sinusoidal, curved, or zigzagged. The sipe 16 is thus a narrow channel/void present in the tread 12 and does not have a width greater than 2 millimeters. The width of the sipe 16 can be measured as the distance of the void in cross-sectional shape between facing walls of the tread 12. This distance would be in the circumferential direction 22 if the sipe 16 extends straight in the axial direction 18. If the sipe 16 is oriented at an angle in its direction of extension in the axial direction 18 then the distance would have a component both in the axial direction 18 and in the circumferential direction 22. It is to be understood that as used herein, when referring to widths, radii, lengths, and other dimensions of the sipe 16 that these numbers refer to the size/geometry of the sipe 16 in its cross-sectional configuration, and not necessarily completely in the axial, radial, and circumferential directions 18, 20, 22 unless the sipe 16 itself is arranged in the manner as shown in FIG. 2 in which its length extends completely in the axial direction 18.

FIG. 3 is a cross-sectional view of the sipe 16 taken along line 3-3 of FIG. 2. The sipe 16 has an upper portion 26 that is located farther from the central axis 24 of the tire 10 in the radial direction 20 than the teardrop void 30 of the sipe 16. The upper portion 26 may have a consistent cross-sectional shape along its entire length, and as shown the shape can be rectangular in shape with a very narrow width compared to its radial length. The upper portion 26 has an upper portion cross-sectional width 28 that is not greater than 2 millimeters. In one embodiment, the cross-sectional width 28 may be 0.6 millimeters, from 0.1-0.6 millimeters, from 0.6-1.0 millimeters, from 0.1-1.0 millimeters, or up to 2 millimeters in accordance with various exemplary embodiments. The upper portion 26 is open at its top which is the part of the upper portion 26 farthest from the central axis 24 in the radial direction 20.

Although shown as being narrow and rectangular in cross-sectional shape, the upper portion 26 may be arranged differently with different cross-sectional shapes in accordance with other exemplary embodiments. The upper portion 26 can have a length that extends in a zigzagged shape, undulated shape, angled in the axial direction, or may extend completely straight in the axial direction 18 in various versions of the sipe 16. The upper portion 26 can be provided with additional elements such as stiffeners, for example as those disclosed in patent application serial number PCT/US2014/058351 having an international filing date of Sep. 30, 2014 and entitled “Stiffeners for Sipe-Molding Members,” the contents of which are incorporated by reference herein in their entirety for all purposes.

The teardrop void 30 is the portion of the sipe 16 that is contiguous with the upper portion 26 and is located closer to the central axis 24 in the radial direction 20. The teardrop void 30 has a transition portion 46 that is contiguous with the upper portion 26. The transition portion 46 includes a convex section 48 that is at an upper terminal end 42 of the teardrop void 30 and is the part of the teardrop void 30 that engages and is closest to the upper portion 26. The convex section 48 has a convex shaped surface on both sides of the teardrop void 30. The convex section 48 has a radius of curvature 52 that is measured by being outside of the teardrop void 30 as shown in FIG. 3. The radius of curvature 52 may be 0.4 millimeters in certain exemplary embodiments. In other embodiments, the radius of curvature 52 may be from 0.2-0.4 millimeters, from 0.4-0.6 millimeters, from 0.2-0.6 millimeters, from 0.6-1.0 millimeters, or up to 1.0 millimeters.

The terms “concave” and “convex” are used herein in association with the description of the teardrop void 30. The terms are used to describe the teardrop void 30 in relation to the shape of the walls of the tread 12 defining the teardrop void 30. For example, the walls of the tread 12 defining the convex section 48 of the transition portion 46 are convex, while the teardrop void 30 at the convex section 48 itself is actually concave in shape. As such, it is to be understood that as used herein, the portions of the teardrop void 30 that are described as being either convex or concave in shape are described in relation to the shape of the wall of the tread 12 defining that particular portion of the teardrop void 30.

The transition portion 46 has a concave section 50 that is contiguous with the convex section 48 and that is located closer to the central axis 24 in the radial direction 20 than the convex section 48. The concave section 50 has a concave surface on both sides of the teardrop void 30. The concave section 50 has a radius of curvature 54 that is measured from the inside of the teardrop void 30. The radius of curvature 54 may be greater than the radius of curvature 52. The radius of curvature 54 may be 0.75 millimeters, from 0.3-0.5 millimeters, from 0.5-0.75 millimeters, from 0.75-1.15 millimeters, from 0.5-1.15 millimeters, from 1.0-1.15 millimeters, or up to 1.15 millimeters in accordance with certain exemplary embodiments.

The transition portion 46 terminates at a middle section 38 of the teardrop void 30. The middle section 38 is contiguous with and engages the concave section 50 and is located closer to the central axis 24 in the radial direction 20 than the concave section 50. The middle section 38 has a straight cross-sectional shape along its entire length 66 in the radial direction 20. In other versions the middle section 38 may include convex, concave, angled, or sinusoidal cross-sectional shapes. The length 66 of the middle section 38 is 1.0 millimeters in certain exemplary embodiments. The length 66 of the middle section 38 may be 0.5 millimeters in other embodiments. In yet other versions of the sipe 16, the length 66 is from 0.5-0.75 millimeters, from 0.5-1.0 millimeters, from 0.75-1.0 millimeters, from 1.0-1.25 millimeters, from 0.75-1.0 millimeters, from 1.25-1.75 millimeters, or up to 2.5 millimeters. The middle section 38 has a cross-sectional width 40 that may be 1.5 millimeters. In other arrangements of the sipe 16, the cross-sectional width 40 is from 0.5-1.0 millimeters, from 1.0-1.5 millimeters, from 1.0-2.0 millimeters, from 1.75-2.2 millimeters, from 2.2-2.3 millimeters, 2.3 millimeters, or up to 2.3 millimeters.

The teardrop void 30 has a maximum cross-sectional width 32 that is the maximum width of the teardrop void 30 in its cross-sectional shape. This width 32 may be measured completely in the circumferential direction 22 when the sipe 16 extends completely in the axial direction 18. When the sipe 16 extends at an angle in the axial direction 18 so as to have components of extension in both the axial direction 18 and the circumferential direction 22, the maximum cross-sectional width 32 is measured from wall to opposing wall of the tread 12 into which the sipe 16 is defined. The maximum cross-sectional width 32 is located at the middle section 38 and is therefore the same as the cross-sectional width 40 of the middle section 38. The maximum cross-sectional width 32 is the greatest width of the teardrop void 30 from wall to wall of the tread 12 in the cross-sectional shape of the teardrop void 30 and can be located at various portions of the teardrop void 30 alternatively to, or in addition to, the middle section 38.

The teardrop void 30 has a bottom 34 that is contiguous with the middle section 38 and is located radially closer to the central axis 24 than the middle section 38. The bottom 34 is located at the terminal end 44 of the teardrop void 30 that is the portion of the teardrop void 30 closest to the central axis 24 in the radial direction 20. The bottom 34 is concave in shape from one end of the middle section 38 to the opposing/opposite end of the middle section 38. The entire bottom 34 can be concave in shape, or the bottom 34 may be differently shaped in accordance with other exemplary embodiments. The bottom 34 has a radius of curvature 36 that is measured from inside of the teardrop void 30. The radius of curvature 36 may be 0.75 millimeters. In other arrangements, the radius of curvature 36 may be from 0.5-0.85 millimeters, from 0.75-1.15 millimeters, or up to 1.15 millimeters. The terminal end 44 of the teardrop void 30 is located a distance 68 from the bottom of the tread 12 in the radial direction 20. The distance 68 may be 0.5 millimeters.

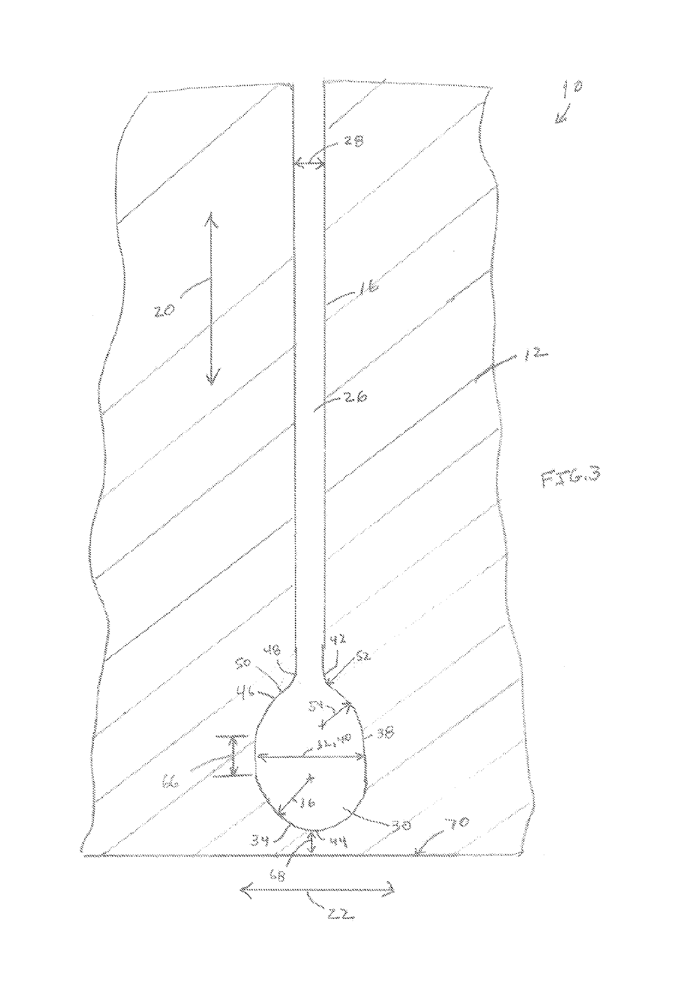

The sipe 16 can be arranged in different manners so that its geometry and size are modified from that disclosed in FIG. 3. Another version of the teardrop void 30 is illustrated with reference to FIG. 4 in which the transition portion 46 is different than that disclosed with reference to FIG. 3. The transition portion 46 does not have a convex section 48 or a concave section 50, but is instead made completely of a conical section 56. The conical section 56 is contiguous with the upper portion 26 and is located at the terminal end 42. The conical section 56 is named so as to describe the shape of this portion of the teardrop void 30 and not the shape of the walls of the tread 12 that define this portion of the teardrop void 30. In cross-sectional shape, the conical section 56 has a trapezoidal shape as shown in FIG. 4. The walls of the tread 12 that define the conical section 56 are straight in cross-sectional shape and are flat. The conical section 56 has a cross-sectional width 58 that becomes larger in the radial direction 20 upon extension of the conical section 56 towards the central axis 24 in the radial direction 20. In this regard, the conical section 56 has its smallest width 58 at the terminal end 42, and has its greatest width 58 at the opposite end of the conical section 56 that engages the middle section 38. The cross-sectional width 58 is largest at the portion of the conical section 56 closest to the central axis 24 in the radial direction 20. The remainder of the teardrop void 30 and the rest of the sipe 16 in FIG. 4 are similar to that previously discussed and a repeat of this information is not necessary.

FIG. 5 shows an alternative exemplary embodiment of the sipe 16 that is similar to the previously discussed embodiments with the exception of the configuration of the transition portion 46. The transition portion 46 includes a convex section 48 at the terminal end 42 that is contiguous with the upper portion 26. The convex section 48 has a radius of curvature 52 and can be configured as previously discussed. The transition portion 46 also has a conical section 56 contiguous with the convex section 48 and located closer to the central axis 24 in the radial direction 20 than the convex section 48. The conical section 56 can be arranged as previously discussed. Next, the transition portion 46 has a concave section 50 contiguous with the conical section 56. The concave section 50 may be arranged as previously discussed, and is located closer to the central axis 24 than the conical section 56 in the radial direction 20. The concave section 50 is contiguous with the middle section 38.

The teardrop void 30 may be arranged in manners different from that shown in FIG. 5 in which the relative positioning of the convex section 48, concave section 50, and conical section 56 are modified. In this regard, the conical section 56 may be the element closest to the central axis 24, or the element farthest from the central axis 24 in the radial direction 20. Any positioning combination of the sections 48, 50 and 56 are possible. Further, one or two of these sections 48, 50 and 56 may be eliminated in other exemplary embodiments. For example, the teardrop void 30 may be set up so that only a convex section 48 and a conical section 56 are present, and so that a concave section 50 is lacking.

The sipe 16 provided in accordance with the present invention has been found to yield surprising results in terms of sculpture robustness as measured through experiments conducted on the tire 10. The bottom 34 radius of curvature 36 was made to be 0.75 millimeters which was increased from that of prior designs of 0.5 millimeters. The sipe 16 design also results in improved rolling resistance via reduced compressive losses. This number is estimated to be at −0.2 kg/t. Further, there is a reduced risk of irregular wear or “flaps” with the sipe 16 geometry and dimensions presented. In this regard, the tread block overhang was reduced from 1.35 millimeters to 0.35 millimeters. The benefits previously discussed may be realized for a sipe 16 with a cross-section like that shown in FIG. 3 in which the radius of curvature 52 is 0.4 millimeters, the radius of curvature 54 is 0.75 millimeters, the length 66 is 1.0 millimeters, the radius of curvature 36 is 0.75 millimeters.

The sipes 16 with the teardrop voids 30 can be formed in a variety of manners. For example, laser sintering can be used as a means to produce the sipes 16 discussed herein. Other standard tire fabrication methods may also be used to produce the sipes 16.

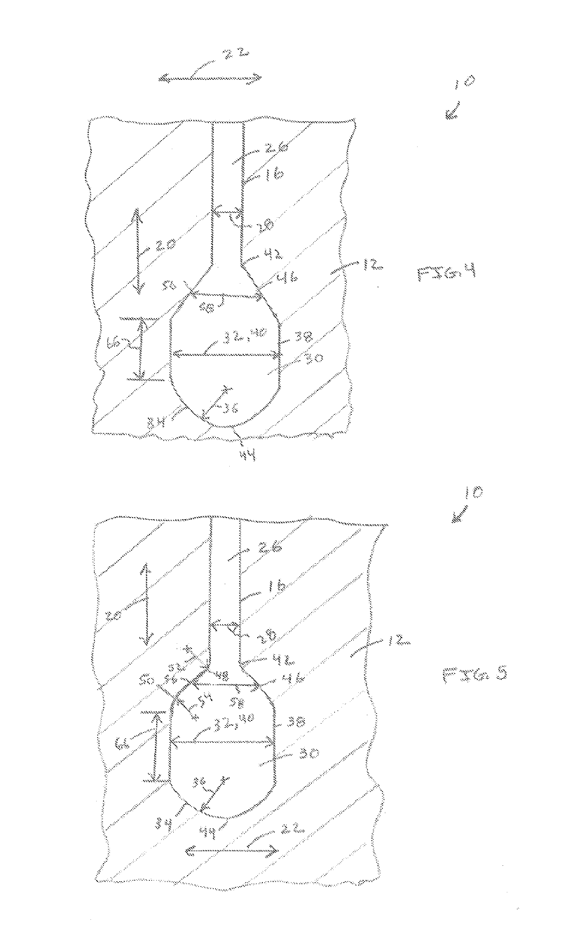

FIG. 6 shows the differences between a prior sipe 62 and a sipe 16 as currently provided. The prior sipe 62 lacks a convex section 48 and a concave section 50 as currently discussed. In as much as a convex section 48 is present in prior sipe 62, the dimensions of the concave section 50 are lacking. Further, the shape of these sections 48 and 50 are different in the current sipe 62. A middle section 38 with the dimensions discussed currently is also lacking in the prior sipe 62. Still further, the bottom of the prior sipe 62 is flat at its terminal end closest to the central axis 24 in the radial direction 20. In contrast, the bottom 34 of the current teardrop void 30 is concave in shape and has a radius of curvature 35 and ends at a point or curve at the terminal end 44 closest to the bottom of the tread 70. The distance 68 from the terminal ends of the sipes 16 and 62 to the bottom of the tread 70 are both 0.5 millimeters, although this distance can be changed in other designs. The width 72 of the prior sipe 62 is 3.5 millimeters, and this distance is greater than the maximum cross-sectional width 32 of the teardrop void 30 that is 2.3 millimeters. As illustrated, the geometry and size of the prior sipe 62 is significantly different than that of the currently provided sipe 16.

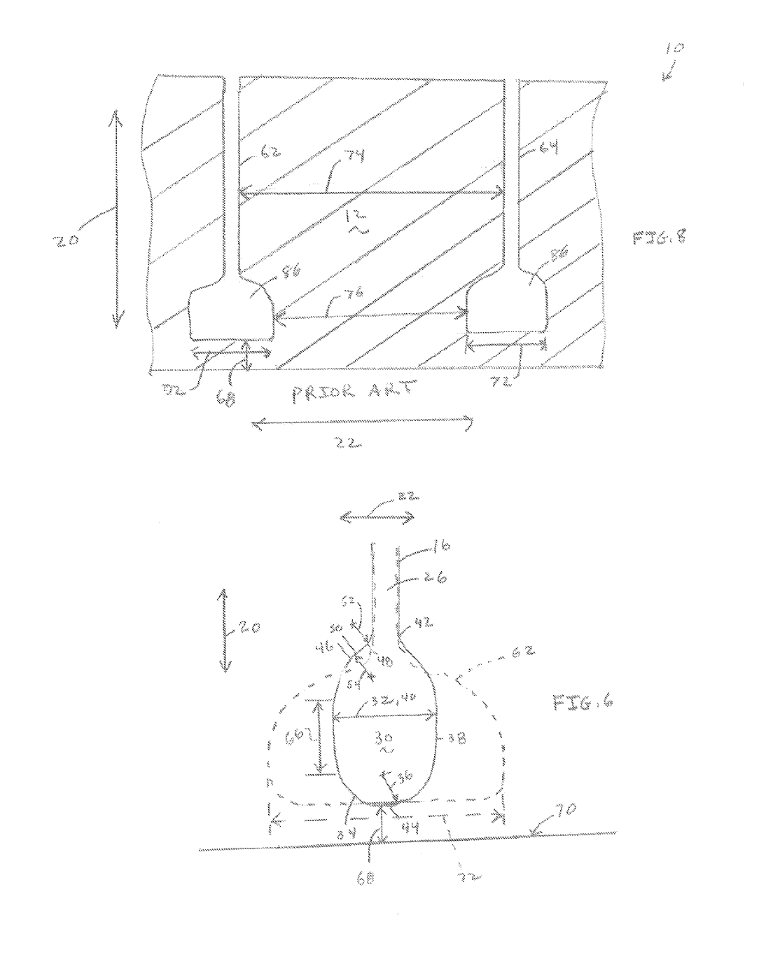

In order to test the performance of the teardrop void 30 and to determine if it is beneficial to tire 10 performance, experiments were conducted on geometries shown in FIGS. 7-10. With reference first to FIG. 7, a prior art sipe arrangement is shown in cross section in which a prior sipe 62 is arranged in an identical manner as a second prior sipe 64. The two sipes 62, 64 have the same width 78 that is 1.3 millimeters. The two sipes 62, 64 are separated from one another a distance 80 that is 9.1 millimeters. This sipe design in FIG. 7 was tested using standard endurance testing that simulates use of the tire 10 until tread block separation was noted.

FIG. 8 shows a pair of sipes 62, 64 in which standard, known teardrop voids 86 were incorporated therein. The teardrop voids 86 each have a maximum width 72 of 3.5 millimeters. The distance 76 in the circumferential direction 22 between the teardrop voids 86 is 6.9 millimeters. The distance 74 in the circumferential direction 22 between the upper portions of the sipes 62 and 64 is 9.6 millimeters. The general geometry of the teardrop voids 86 is similar to that as described with respect to the prior sipe 62 of FIG. 6, although the cross-sectional shape is somewhat different as illustrated. The tire 10 of FIG. 8 was likewise tested using standard endurance testing until tread block separation was noted. It was found that the tread block separation of the design in FIG. 8 occurred 43.6 hours before the tread block separation of the design in FIG. 7 which is taken to mean that the design in FIG. 8 is less robust that than of FIG. 7. Also, significant cracking was noted in the tread block design of FIG. 8 in comparison to that of FIG. 7 after the same amount of time both designs were tested.

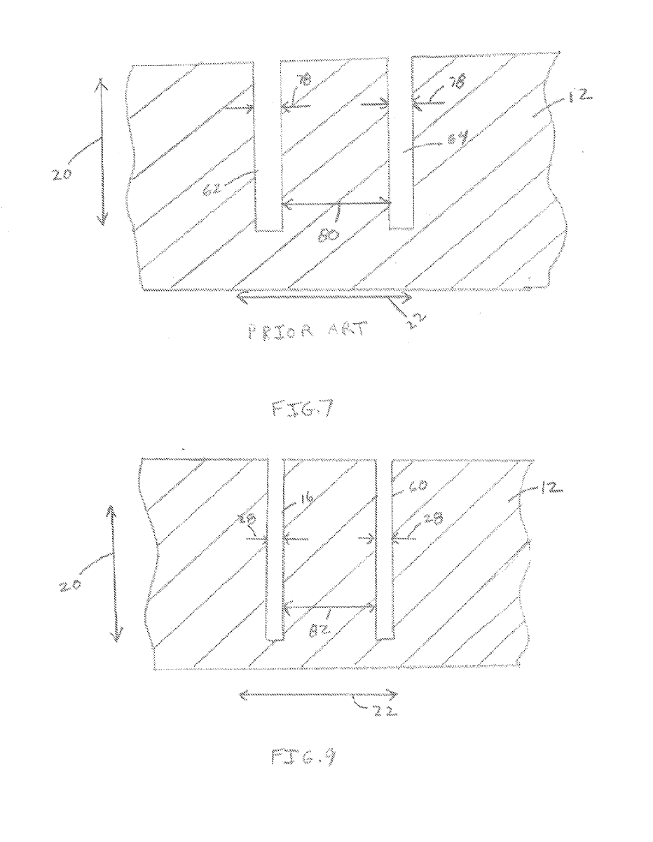

FIG. 9 shows a pair of sipes 16 and 60 that each have an upper portion cross-sectional width 28 of 0.6 millimeters. The sipes 16 and 60 are separated from one another by a distance 82 that is 9.6 millimeters. These sipes 16, 60 have a much smaller width 28 as compared to the widths 78 of the sipes 62, 64 of FIG. 7. The sipes 16, 60 are referred to as micro teardrop sipes because of their small widths 28. FIG. 10 is a design of the sipes 16, 60 in which teardrop voids 30 have been added to the terminal ends of the upper portions 26 of the sipes 16, 60 at the locations closest to the central axis 24 in the radial direction 20. The sipes 16, 60 are again spaced from one another a distance 82 that is 9.6 millimeters, and the widths 28 are the same as that of the widths 28 in FIG. 9 of 0.6 millimeters. The teardrop voids 30 are circular in cross-sectional shape so as to be concave around their entire perimeter. The radius of curvature 84 of the teardrop voids 30 are 0.6 millimeters.

Endurance experiments were conducted on the sipe 16, 60 design in both FIGS. 9 and 10. It was discovered that the design with the teardrop voids 30 of FIG. 10 were able to run for 28 hours longer than the design of FIG. 9 with respect to tread block separation. In other words, when tread block separation occurs in the design of FIG. 9, the design of FIG. 10 does not have tread block separation and is in fact able to run for another 28 hours until tread block separation was noted. It was also noted during the endurance testing that 78%-96% less cracking was found in the design in FIG. 10 than in the design in FIG. 9 after the same amount of testing. Although the geometry of the teardrop void 30 in FIG. 10 is not the same as that of previously described embodiments, the experimental tests show that a micro teardrop void 30 is capable of significantly improving endurance characteristics over known teardrop void 86 configurations.

While the present subject matter has been described in detail with respect to specific embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A tire, comprising:
tread;
a sipe located in the tread, wherein the sipe has an upper portion that has an upper portion cross-sectional width, wherein the sipe has a teardrop void located closer to a central axis of the tire than the upper portion, wherein the teardrop void has a maximum cross-sectional width that is not greater than 2.3 millimeters.

2. The tire as set forth in claim 1, wherein the maximum cross-sectional width is 1.5 millimeters.

3. The tire as set forth in claim 1 or 2, wherein the teardrop void has a bottom that is the portion of the teardrop void that is closest to the central axis of the tire in the radial direction, wherein the bottom is concave in cross-sectional shape and has a radius of curvature that is not greater than 1.15 millimeters.

4. The tire as set forth in claim 3, wherein the radius of curvature of the bottom in cross-sectional shape is 0.75 millimeters.

5. The tire as set forth in any one of the preceding claims, wherein the teardrop void has a middle section that has a constant cross-sectional width, wherein the middle section is not located at a terminal end of the teardrop void in a radial direction of the tire, wherein the maximum cross-sectional width of the teardrop void is located at the middle section.

6. The tire as set forth in claim 5, wherein the middle section has a length in the radial direction that is not greater than 1.25 millimeters.

7. The tire as set forth in claim 6, wherein the length of the middle section in the radial direction is 1.0 millimeters.

8. The tire as set forth in any one of the preceding claims, wherein the teardrop void has a transition portion that is contiguous with the upper portion of the sipe;
wherein the transition portion has a convex section that is contiguous with the upper portion of the sipe, wherein the convex section is convex in cross-sectional shape, wherein the convex section is located at a terminal end of the teardrop void in a radial direction of the tire;
wherein the transition portion has a concave section that is contiguous with the convex section, wherein the concave section is concave in cross-sectional shape, wherein the convex section is located between the concave section and the upper portion in the radial direction of the tire.

9. The tire as set forth in claim 8, wherein the concave section has a radius of curvature that is not greater than 1.15 millimeters, and wherein the convex section has a radius of curvature that is 0.4 millimeters.

10. The tire as set forth in claim 9, wherein the radius of curvature of the concave section is 0.75 millimeters.

11. The tire as set forth in any one of claims 1-7, wherein the teardrop void has a transition portion that is contiguous with the upper portion of the sipe;
wherein the transition portion is made completely of a conical section that is contiguous with the upper portion of the sipe, wherein the conical section is trapezoidal in cross-sectional shape, wherein a cross-sectional width of the conical section increases upon extension of the conical section away from the upper portion in a radial direction of the tire.

12. The tire as set forth in any one of claims 1-7, wherein the teardrop void has a transition portion that is contiguous with the upper portion of the sipe;
wherein the transition portion has a convex section that is convex in cross-sectional shape;
wherein the transition portion has a concave section that is concave in cross-sectional shape;
wherein the transition portion has a conical section that is trapezoidal in cross-sectional shape, wherein a width of the conical section increases upon extension of the conical section away from the upper portion in a radial direction of the tire.

13. The tire as set forth in claim 12, wherein the convex section is contiguous with the upper portion of the sipe, wherein the convex section has a radius of curvature that is 0.4 millimeters;
wherein the concave section has a radius of curvature that is not greater than 1.15 millimeters;
wherein the conical section is contiguous with both the convex section and the concave section, and wherein the conical section is located between the convex section and the concave section in the radial direction of the tire.
